(19) United States
(12) Patent Application Publication
(10) Pub. No.: US 2026/0364945 A1
(43) Pub. Date: Nov. 19, 2026

(54) DIAPHRAGM PUMP, LIQUID EJECTION DEVICE, AND INKJET RECORDING APPARATUS

(71) Applicant: KYOCERA Document Solutions Inc., Osaka (JP)

(72) Inventors: Koichi Imanaka, Osaka (JP); Kenichi Satake, Osaka (JP); Hideki Ishida, Osaka (JP); Shogo Yoneda, Osaka (JP); Nanako Nishida, Osaka (JP); Shun Tsuboi, Osaka (JP)

(21) Appl. No.: 19/650,743

(22) Filed: Apr. 17, 2026

(30) Foreign Application Priority Data
May 13, 2025 (JP) 2025-080262

(51) Int. Cl. B41J 2/175; B41J 2/18; F04B 43/02

(52) U.S. Cl. CPC B41J 2/17596; B41J 2/18; F04B 43/02; B41P 2251/11

(57) ABSTRACT

A main body includes a plurality of pump chambers, an inflow path, an anterior chamber positioned midway through the inflow path, an outflow path, a posterior chamber positioned midway through the outflow path, a return path from the posterior chamber to the anterior chamber, and a return chamber positioned midway through the return path. A relief valve is arranged in the return chamber, blocks the return path, and releases the block of the return path when a difference between a pressure of the anterior chamber and a pressure of the posterior chamber exceeds an upper limit.

### INCORPORATION BY REFERENCE

This application is based upon and claims the benefit of priority from the corresponding Japanese Patent Application No. 2025-080262 filed on May 13, 2025, the entire contents of which are incorporated herein by reference.

### BACKGROUND

The present disclosure relates to a diaphragm pump including a relief valve arranged on a return path that communicates with an outflow path side and an inflow path side, a liquid ejection device including the diaphragm pump, and an inkjet recording apparatus.

An inkjet recording apparatus includes an ink ejection device which ejects ink droplets from an inkjet head onto a sheet to form an image on the sheet. The ink ejection device is an example of a liquid ejection device which ejects liquid droplets. The inkjet head is an example of a liquid ejection head.

The inkjet recording apparatus includes an ink supply device which supplies ink from an ink accumulation portion to the inkjet head via a supply path. The ink supply device is an example of a liquid supply device which supplies liquid to the liquid ejection head.

The liquid supply device includes a pressure pump arranged on the supply path. For example, it is known that a diaphragm pump is used as the pressure pump.

### SUMMARY

A diaphragm pump according to an aspect of the present disclosure includes a main body, a plurality of diaphragms, a crank mechanism, a plurality of first check valves, a plurality of second check valves, and a relief valve. The main body includes a plurality of pump chambers each formed with an opening, an inflow path through which liquid that flows from an inflow port toward the plurality of pump chambers flows, an anterior chamber positioned midway through the inflow path, an outflow path through which the liquid that flows from the plurality of pump chambers toward an outflow port flows, a posterior chamber positioned midway through the outflow path, a return path extending from the posterior chamber to the anterior chamber, and a return chamber positioned midway through the return path. The plurality of diaphragms are capable of expanding and contracting, each of the plurality of diaphragms blocking the opening of the plurality of pump chambers. The crank mechanism is coupled to the plurality of diaphragms and receives power to cause the plurality of diaphragms to expand and contract. The plurality of first check valves permit a flow of the liquid in a first forward direction from the anterior chamber toward the plurality of pump chambers on the inflow path, and block the flow of the liquid in an opposite direction from the first forward direction. The plurality of second check valves permit the flow of the liquid in a second forward direction from the plurality of pump chambers toward the posterior chamber on the outflow path, and block the flow of the liquid in an opposite direction from the second forward direction. The relief valve is arranged in the return chamber, blocks the return path, and releases the block of the return path when a difference between a pressure of the anterior chamber and a pressure of the posterior chamber exceeds an upper limit.

A liquid discharge device according to another aspect of the present disclosure includes a liquid ejection head, a supply path, and the diaphragm pump coupled to the supply path. The liquid ejection head includes a plurality of nozzles and ejects liquid droplets from each of the plurality of nozzles. Liquid to be supplied to the liquid ejection head flows through the supply path. The diaphragm pump pressurizes the liquid in the supply path.

An inkjet recording apparatus according to another aspect of the present disclosure includes: a sheet conveying device which conveys a sheet; and the liquid ejection device which ejects ink droplets onto the sheet conveyed, to form an image on the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an inkjet recording apparatus according to an embodiment;

FIG. 2 is a configuration diagram of an ink supply device and an inkjet head in the inkjet recording apparatus according to the embodiment;

FIG. 3 is a perspective view of an upper surface side of a diaphragm pump in the inkjet recording apparatus according to the embodiment;

FIG. 4 is a perspective view of a lower surface side of the diaphragm pump in the inkjet recording apparatus according to the embodiment;

FIG. 5 is a vertical cross-sectional view of the diaphragm pump in the inkjet recording apparatus according to the embodiment;

FIG. 6 is a cross-sectional plan view of a second layer of the diaphragm pump in the inkjet recording apparatus according to the embodiment;

FIG. 7 is a cross-sectional plan view of a third layer of the diaphragm pump in the inkjet recording apparatus according to the embodiment;

FIG. 8 is a cross-sectional plan view of a fourth layer of the diaphragm pump in the inkjet recording apparatus according to the embodiment;

FIG. 9 is a cross-sectional plan view of a fifth layer of the diaphragm pump in the inkjet recording apparatus according to the embodiment; and

FIG. 10 is a cross-sectional plan view of a sixth layer of the diaphragm pump in the inkjet recording apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### Configuration of inkjet recording apparatus 10

An inkjet recording apparatus 10 according to the embodiment is an image forming apparatus capable of executing print processing by an inkjet method. The print processing is processing of forming an image on a sheet 9. The sheet 9 is a sheet-like image forming medium such as paper or a resin film.

It is noted that the inkjet recording apparatus 10 may be a facsimile apparatus, a copying machine, a multifunction peripheral, or the like that is capable of executing the print processing by the inkjet method.

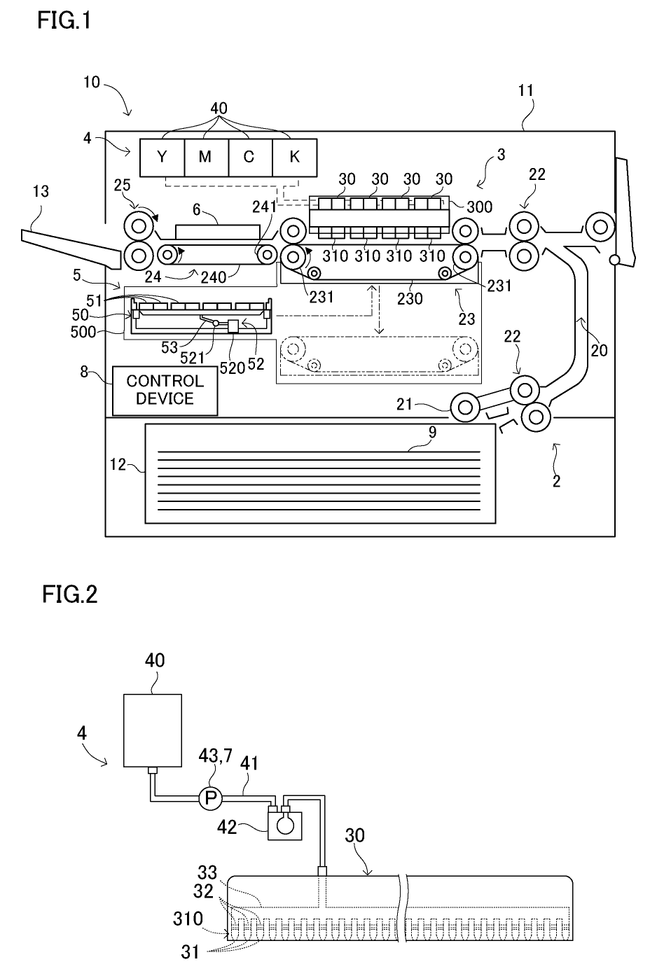

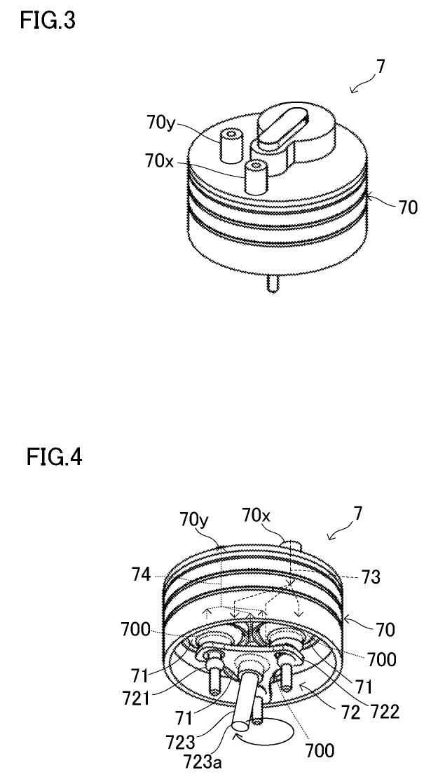

As shown in FIG. 1, the inkjet recording apparatus 10 includes a sheet storing portion 12, a sheet conveying device 2, an ink ejection device 3, a drying device 6, a control device 8, and the like. The sheet conveying device 2, the ink ejection device 3, the drying device 6, and the control device 8 are housed in a housing 11 that forms a main body.

The ink ejection device 3 includes an ink supply device 4, a plurality of inkjet heads 30, and an ink discharge device 5. The ink supply device 4 supplies ink to the plurality of inkjet heads 30. The plurality of inkjet heads 30 are integrated as a head unit 300.

Each of the inkjet heads 30 includes a nozzle group 310 constituted of a plurality of nozzles 31 (see FIGS. 1 and FIG. 2). Each of the plurality of nozzles 31 ejects ink droplets. The ink discharge device 5 executes ink discharge processing for discharging ink from the plurality of inkjet heads 30.

The sheet storing portion 12 is capable of storing a plurality of sheets 9. The sheet conveying device 2 conveys each of the sheets 9 stored in the sheet storing portion 12 along a sheet conveying path 20, and further discharges the sheets 9 from the sheet conveying path 20 onto a discharge tray 13.

The sheet conveying device 2 includes a sheet feed mechanism 21, a plurality of conveying roller pairs 22, a main conveying unit 23, a subsequent conveying unit 24, a discharge roller pair 25, and the like. The sheet feed mechanism 21 feeds each of the sheets 9 from the sheet storing portion 12 to the sheet conveying path 20.

The plurality of conveying roller pairs 22 take over the conveyance of the sheet 9 from the sheet feed mechanism 21 and convey the sheet 9 toward the main conveying unit 23.

The main conveying unit 23 is arranged below the plurality of inkjet heads 30. The main conveying unit 23 conveys each of the sheets 9 along the nozzle groups 310 of the plurality of inkjet heads 30.

In the main conveying unit 23, a plurality of tension rollers 231 support and rotate an endless main conveying belt 230. Thus, the main conveying unit 23 conveys each of the sheets 9 while the sheet 9 is placed on an upper surface of the main conveying belt 230, and further feeds each of the sheets 9 to the subsequent conveying unit 24. A portion between the upper surface of the main conveying belt 230 and the plurality of inkjet heads 30 constitutes a part of the sheet conveying path 20.

The subsequent conveying unit 24 is arranged on a downstream side of the main conveying unit 23 positioned at a reference position, in a sheet conveying direction.

In the subsequent conveying unit 24, a plurality of tension rollers 241 support and rotate an endless subsequent conveying belt 240. Thus, the subsequent conveying unit 24 conveys each of the sheets 9 on which an image has been formed while the sheet 9 is placed on an upper surface of the subsequent conveying belt 240, and further feeds each of the sheets 9 to the discharge roller pair 25.

The drying device 6 blows warm air onto each of the sheets 9 conveyed by the subsequent conveying unit 24, to dry ink on each of the sheets 9. The discharge roller pair 25 discharges each of the sheets 9 on which an image has been formed onto the discharge tray 13.

### Configuration of inkjet head 30

Each of the inkjet heads 30 executes ink ejection processing for ejecting ink droplets from each of the plurality of nozzles 31. The plurality of inkjet heads 30 eject ink droplets onto each of the sheets 9 conveyed by the main conveying unit 23 to form an image on each of the sheets 9.

Each of the inkjet heads 30 includes an introduction path 33 in communication with the plurality of nozzles 31 (see FIG. 2). Ink supplied by the ink supply device 4 is supplied to the plurality of nozzles 31 via the introduction path 33.

Furthermore, each of the inkjet heads 30 includes a plurality of piezoelectric elements 32 respectively corresponding to the plurality of nozzles 31 (see FIG. 2). When an ejection drive signal is supplied from the control device 8, each of the piezoelectric elements 32 vibrates. Each of the piezoelectric elements 32 vibrates to pressurize the ink and cause the ink to be ejected from the nozzle 31.

The ink ejection processing is an example of liquid ejection processing for ejecting liquid droplets. Each of the inkjet heads 30 is an example of a liquid ejection head that executes the liquid ejection processing. The ink ejection device 3 is an example of a liquid ejection device including the liquid ejection head.

### Configuration of ink supply device 4

The ink supply device 4 includes a plurality of ink containers 40 and a plurality of supply paths 41 (see FIG. 2). Each of the ink containers 40 accumulates ink therein. The supply paths 41 are respectively connected to the plurality of ink containers 40 and the plurality of inkjet heads 30.

The plurality of ink containers 40 accumulate ink of different colors. The plurality of inkjet heads 30 eject ink of different colors. In the present embodiment, the ink colors are four colors of black, cyan, magenta, and yellow.

Each of the ink containers 40 is an example of a liquid accumulation portion that accumulates liquid therein. The ink is an example of liquid.

Each of the supply paths 41 is a flow path through which the ink supplied from the ink container 40 to the inkjet head 30 flows.

The ink supply device 4 supplies the ink from each of the ink containers 40 to each of the inkjet heads 30 via each of the supply paths 41.

The ink supply device 4 further includes a plurality of pressure adjustment valve devices 42 and a plurality of pressure pumps 43 coupled to the plurality of supply paths 41, respectively (see FIG. 2).

Each of the pressure adjustment valve devices 42 is temporarily switched from a supply path closed state to a supply path opened state in accordance with a pressure change that occurs in the supply path 41 due to the ejection of ink droplets from each of the inkjet heads 30. The supply path closed state is a state where the supply path 41 is blocked.

On the other hand, the supply path opened state is a state where the block of the supply path 41 is released. By the pressure adjustment valve device 42 being switched to the supply path opened state, ink is replenished into the inkjet head 30 in accordance with the ejection of ink droplets from the inkjet head 30.

Each of the pressure pumps 43 is arranged at a portion of the supply path 41 between the ink container 40 and the pressure adjustment valve device 42. Each of the pressure pumps 43 pressurizes the ink in the supply path 41.

In the present embodiment, a diaphragm pump 7 is adopted as each of the pressure pumps 43 (see FIGS. 2 - FIG. 4).

In the ink ejection device 3, the ink discharge device 5 executes the ink discharge processing for discharging air bubbles or foreign matter in each of the inkjet heads 30 together with the ink. The ink discharge device 5 is an example of a liquid discharge device that ejects liquid from inside the liquid ejection head.

### Configuration of ink discharge device 5

The ink discharge device 5 includes a cap unit 50, a unit movement device 500, a discharge path 53, and a suction device 52 (see FIG. 1). The discharge path 53 is a flow path for ink that flows from inside of a cap 51 to inside of an ink recovery vessel 520.

The cap unit 50 includes the cap 51 capable of covering the nozzle groups 310 of the plurality of inkjet heads 30 (see FIG. 1). The discharge path 53 is in communication with the inside of the cap 51 and the inside of the ink recovery vessel 520. The suction device 52 sucks in air from inside the cap 51 covering the nozzle groups 310.

The ink discharge processing is processing of sucking in air from inside the cap 51 to discharge the ink in each of the plurality of inkjet heads 30 via the cap 51 and the discharge path 53.

By executing the ink discharge processing, the ink inside each of the inkjet heads 30 is discharged, and new ink is supplied to each of the inkjet heads 30 by the ink supply device 4.

The cap unit 50 is supported so as to be movable. The unit movement device 500 moves the cap unit 50.

In the example shown in FIG. 1, the unit movement device 500 moves the main conveying unit 23 from a conveying position to a conveyance evacuation position, and then moves the cap unit 50 from a cap evacuation position to a cap position.

The conveying position is a position of the main conveying unit 23 when the main conveying belt 230 is arranged along the nozzle group 310. The conveyance evacuation position is a position farther from the head unit 300 than the conveying position.

The cap evacuation position is a position that does not interference with the head unit 300 and the main conveying unit 23. The cap position is a position of the cap unit 50 when the cap 51 covers the nozzle groups 310 of the plurality of inkjet heads 30.

It is noted that the unit movement device 500 may move the head unit 300 instead of the main conveying unit 23. In this case, the unit movement device 500 moves the head unit 300 between a reference position and a head evacuation position.

The reference position is a position of the head unit 300 when the nozzle groups 310 are arranged along the main conveying belt 230. The head evacuation position is a position farther from the main conveying belt 230 than the reference position.

The suction device 52 is operated under a situation where the cap unit 50 is positioned at the cap position. Thus, the ink discharge processing is executed.

The suction device 52 includes a suction pump 521 arranged on the discharge path 53 (see FIG. 1). The suction pump 521 causes the ink in each of the inkjet heads 30 to flow into the ink recovery vessel 520 via the cap 51 and the discharge path 53.

Incidentally, when the diaphragm pump 7 is adopted as the pressure pump 43, a pressure reduction mechanism is required to prevent an excessive increase of an ejection pressure of the diaphragm pump 7 from occurring. It is desirable for the pressure pump 43 and the pressure reduction mechanism to be arranged in a compact manner in the ink ejection device 3.

In the present embodiment, the diaphragm pump 7 has a configuration for realizing a compact arrangement of the ink supply device 4 including the mechanism for adjusting the ejection pressure of the diaphragm pump 7.

Furthermore, if air bubbles are accumulated inside the diaphragm pump 7, malfunction of the diaphragm pump 7 is likely to occur. The diaphragm pump 7 has a structure that makes it difficult for the air bubbles to be accumulated inside.

### Configuration of diaphragm pump 7

The diaphragm pump 7 includes a main body 70, a plurality of diaphragms 71, and a crank mechanism 72 (see FIG. 4).

The main body 70 includes an inflow port 70x and an outflow port 70y. The main body 70 further includes a plurality of liquid chambers and a plurality of liquid flow paths inside. A cross-sectional area of each of the liquid chambers is larger than a cross-sectional area of each of the liquid flow paths.

The plurality of liquid chambers include a plurality of pump chambers 700, an anterior chamber 701, and a posterior chamber 702 (see FIG. 5). The plurality of liquid flow paths include an inflow path 73 having an inflow port 70x as a base end, and an outflow path 74 having an outflow port 70y as a terminal end (see FIG. 4).

The inflow path 73 is a flow path through which liquid that flows from the inflow port 70x toward the plurality of pump chambers 700 flows. The outflow path 74 is a flow path through which liquid that flows from the plurality of pump chambers 700 toward the outflow port 70y flows.

Each of the plurality of pump chambers 700 is a liquid chamber formed with an opening 700a (see FIG. 5). Each of the plurality of diaphragms 71 is a member that can be expanded and contracted. The plurality of diaphragms 71 are bonded to the main body 70 and block the openings 700a of the plurality of pump chambers 700, respectively.

The opening 700a is formed at a lower end of each of the pump chambers 700. The plurality of diaphragms 71 block the openings 700a at the lower ends of the plurality of pump chambers 700.

The anterior chamber 701 is one of the plurality of liquid chambers that is positioned midway through the inflow path 73. The posterior chamber 702 is one of the plurality of liquid chambers that is positioned midway through the outflow path 74.

The liquid that has flowed into the inflow port 70x flows into the plurality of pump chambers 700 via the anterior chamber 701. The liquid in the plurality of pump chambers 700 flows out of the outflow port 70y via the posterior chamber 702.

The diaphragm pump 7 further includes a plurality of first check valves 76 and a plurality of second check valves 77 (see FIGS. 5, FIG. 7, and FIG. 9).

In descriptions below, a direction from the anterior chamber 701 toward the plurality of pump chambers 700 on the inflow path 73 will be referred to as a first forward direction. In addition, a direction from the plurality of pump chambers 700 toward the posterior chamber 702 on the outflow path 74 will be referred to as a second forward direction.

The plurality of first check valves 76 are arranged so as to respectively correspond to the plurality of pump chambers 700. The plurality of first check valves 76 permit a flow of the liquid in the first forward direction on the inflow path 73, and block the flow of the liquid in an opposite direction from the first forward direction.

The plurality of second check valves 77 are arranged so as to respectively correspond to the plurality of pump chambers 700. The plurality of second check valves 77 permit the flow of the liquid in the second forward direction on the outflow path 74, and block the flow of the liquid in an opposite direction from the second forward direction.

The crank mechanism 72 is coupled to the plurality of diaphragms 71 and receives power to cause the plurality of diaphragms 71 to expand and contract (see FIG. 4).

The crank mechanism 72 includes a plurality of coupling members 721 respectively coupled to the plurality of diaphragms 71, a swing member 722 that transmits power to the plurality of coupling members 721, and a circling member 723 that extends from the swing member 722 (see FIG. 4).

An effort portion 723a, which is one end of the circling member 723, is coupled to a circling mechanism (not shown) and receives a rotational force from the circling mechanism. The circling mechanism causes the effort portion 723a to circle, to thus cause the swing member 722 to swing. The swing member 722 swings to cause each of the plurality of coupling members 721 to reciprocate in the up-down direction. The swing member 722 causes each of the plurality of coupling members 721 to reciprocate in the up-down direction while shifting a phase.

When each of the coupling members 721 is lowered, each of the diaphragms 71 expands, thus increasing a volume of each of the pump chambers 700. When each of the coupling members 721 is raised, each of the diaphragms 71 contracts, thus decreasing the volume of each of the pump chambers 700.

When each of the coupling members 721 is lowered sequentially, the liquid flows from the anterior chamber 701 into each of the pump chambers 700 via each of the plurality of first check valves 76. The same amount of liquid as the amount of liquid flowing from the anterior chamber 701 to each of the pump chambers 700 flows into each of the pump chambers 700 from the inflow port 70x.

When each of the coupling members 721 is raised sequentially, the liquid flows from each of the pump chambers 700 into the posterior chamber 702 via each of the plurality of second check valves 77. The liquid further passes through the posterior chamber 702 and flows out from the outflow port 70y.

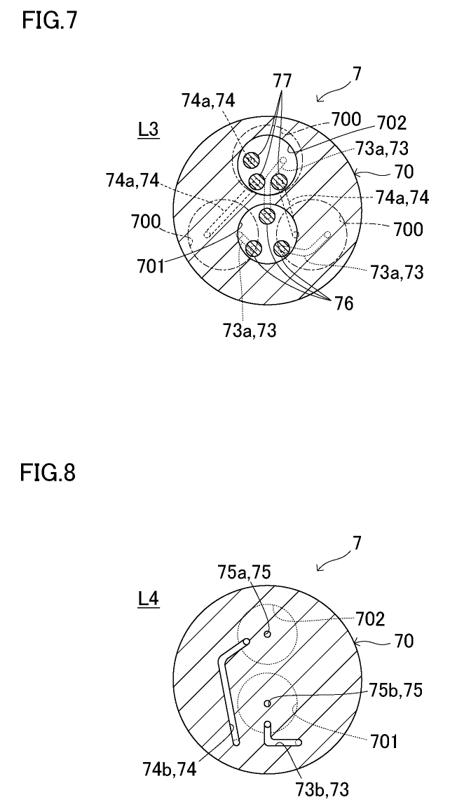

In the example shown in FIG. 4, the main body 70 includes three pump chambers 700. Therefore, the diaphragm pump 7 includes three first check valves 76 and three second check valves 77 respectively corresponding to the three pump chambers 700 (see FIG. 7).

In the diaphragm pump 7, the plurality of liquid flow paths in the main body 70 further include a return path 75 (see FIG. 5 and FIG. 10). The return path 75 is a flow path that leads from the posterior chamber 702 to the anterior chamber 701. The return path 75 is in communication with the posterior chamber 702 and the anterior chamber 701.

The plurality of liquid chambers of the main body 70 further include a return chamber 703 (see FIG. 5). The return chamber 703 is positioned midway through the return path 75. The return path 75 includes a first return path 75a in communication with the posterior chamber 702 and the return chamber 703 and a second return path 75b in communication with the return chamber 703 and the anterior chamber 701 (see FIG. 5).

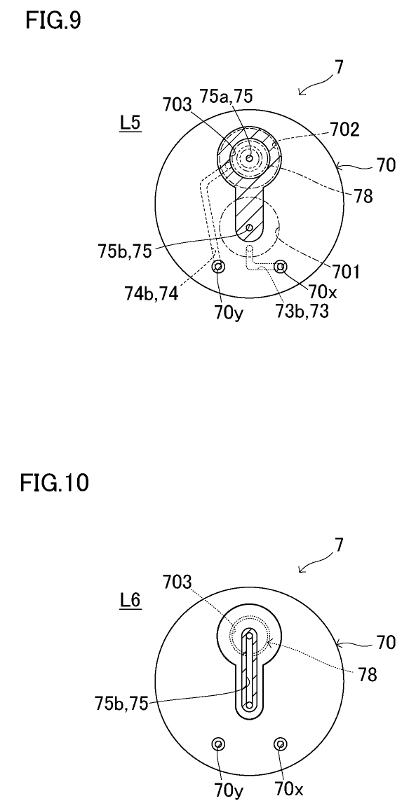

The diaphragm pump 7 further includes a relief valve 78 arranged in the return chamber 703 (see FIGS. 5 and FIG. 9). In FIG. 9, the relief valve 78 is indicated by an imaginary line (two-dot chain line).

The relief valve 78 blocks the return path 75. When a differential pressure exceeds an upper limit, the relief valve 78 releases the block of the return path 75. The differential pressure is a difference between a pressure of the anterior chamber 701 and a pressure of the posterior chamber 702.

In the diaphragm pump 7, a pressure of an upper inflow path 73b is the same as the pressure of the anterior chamber 701. Similarly, a pressure of an upper outflow path 74b is the same as the pressure of the posterior chamber 702. Therefore, the differential pressure is also a difference between the pressure of the upper inflow path 73b and the pressure of the upper outflow path 74b.

The relief valve 78 includes a valve member 78a that closes the first return path 75a and a spring 78b that biases the valve member 78a (see FIG. 5). The spring 78b is an elastic member that elastically biases the valve member 78a toward a closing position. The closing position is a position at which the first return path 75a is closed.

When the pressure of the posterior chamber 702 and the upper outflow path 74b increases, the differential pressure increases. The upper limit of the differential pressure is the differential pressure when a force that acts on the valve member 78a due to the differential pressure and a force of the spring 78b retaining the valve member 78a at the closing position are balanced. When the differential pressure exceeds the upper limit, the valve member 78a moves from the closing position to an opening position.

By the valve member 78a moving to the opening position, the block of the return path 75 is released. When the block of the return path 75 is released, the liquid returns to the anterior chamber 701 and the upper inflow path 73b, and the pressure of the posterior chamber 702 and the upper outflow path 74b decreases.

The return path 75, the return chamber 503, and the relief valve 78 constitute the pressure reduction mechanism that prevents an excessive increase of the ejection pressure of the diaphragm pump 7 from occurring. The diaphragm pump 7 incorporates the pressure reduction mechanism therein in a compact manner.

By adopting the diaphragm pump 7, the ink supply device 4 including the pressure reduction mechanism can be arranged in a compact manner.

The main body 70 includes a first layer L1 including the plurality of pump chambers 700, a second layer L2 stacked on the first layer L1, a third layer L3 stacked on the second layer L2, a fourth layer L4 stacked on the third layer L3, a fifth layer L5 stacked on the fourth layer L4, and a sixth layer L6 stacked on the fifth layer L5 (see FIG. 5).

For example, the main body 70 has a structure in which a plurality of resin members are stacked and coupled to one another in the up-down direction.

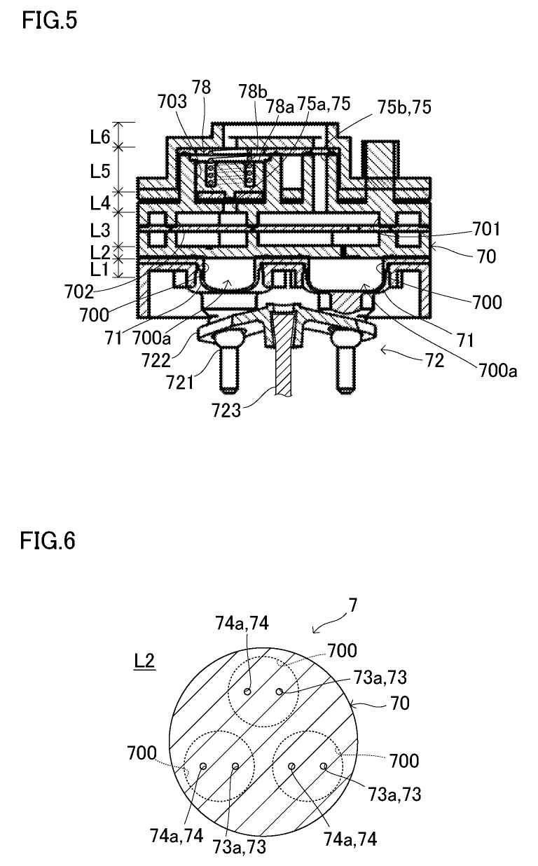

FIGS. 6 - FIG. 10 are cross-sectional plan views of the diaphragm pump 7. FIGS. 6 - FIG. 10 show the cross-sectional plan views taken along horizontal planes that pass through the second layer L2, the third layer L3, the fourth layer L4, the fifth layer L5, and the sixth layer L6, respectively.

In FIG. 6, the plurality of pump chambers 700 in the first layer L1 are indicated by dashed lines.

The inflow path 73 includes a plurality of lower inflow paths 73a in communication with the plurality of pump chambers 700 and the anterior chamber 701, and the upper inflow path 73b extending from the anterior chamber 701 to the inflow port 70x (see FIGS. 6 - FIG. 9). One end of the upper inflow path 73b is in communication with the anterior chamber 701.

Meanwhile, the outflow path 74 includes a plurality of lower outflow paths 74a in communication with the plurality of pump chambers 700 and the posterior chamber 702, and the upper outflow path 74b extending from the outflow port 70y to the posterior chamber 702 (see FIGS. 6 - FIG. 9). One end of the upper outflow path 74b is in communication with the posterior chamber 702.

The anterior chamber 701 and the posterior chamber 702 are formed in the third layer L3 (see FIG. 7). That is, the anterior chamber 701 and the posterior chamber 702 are positioned above the plurality of pump chambers 700.

The plurality of lower inflow paths 73a and the plurality of lower outflow paths 74a are formed in the second layer L2 (see FIGS. 6 and FIG. 7), while the upper inflow path 73b and the upper outflow path 74b are formed across the fourth layer L4 and the fifth layer L5 (see FIGS. 8 and FIG. 9).

More specifically, the plurality of lower inflow paths 73a are in communication with top portions of the plurality of pump chambers 700 and a bottom portion of the anterior chamber 701 (see FIGS. 6 and FIG. 7). Similarly, the plurality of lower outflow paths 74a are in communication with the top portions of the plurality of pump chambers 700 and the bottom portion of the anterior chamber 701 (see FIGS. 6 and FIG. 7).

Meanwhile, the upper inflow path 73b is in communication with a top portion of the anterior chamber 701 (see FIG. 8). Similarly, the upper outflow path 74b is in communication with a top portion of the posterior chamber 702 (see FIG. 8).

In FIG. 7, the plurality of pump chambers 700 in the first layer L1 are indicated by dash-dotted lines, and the lower inflow paths 73a in the second layer L2 are indicated by dashed lines. In FIG. 8, the anterior chamber 701 and the posterior chamber 702 in the third layer L3 are indicated by dashed lines.

In FIG. 9, the anterior chamber 701 and the posterior chamber 702 in the third layer L3 are indicated by dash-dotted lines, and the upper inflow path 73b and the upper outflow path 74b in the fourth layer L4 are indicated by dashed lines.

The plurality of lower outflow paths 74a are formed in the second layer L2, and the anterior chamber 701 and the posterior chamber 702 are formed in the third layer L3 (see FIGS. 6 and FIG. 7). In addition, the upper inflow path 73b is formed across the fourth layer L4 and the fifth layer L5 (see FIGS. 6 - FIG. 8).

The return chamber 703 is formed in the fifth layer L5 (see FIGS. 5 and FIG. 9). The return chamber 703 is positioned above the posterior chamber 702 (see FIGS. 5 and FIG. 9).

The return path 75 includes the first return path 75a in communication with the posterior chamber 702 and the return chamber 703 and the second return path 75b in communication with the return chamber 703 and the anterior chamber 701 (see FIGS. 5 and FIG. 9).

The first return path 75a is formed in the fourth layer L4, and the second return path 75b is formed from the fourth layer L4 to the sixth layer L6 (see FIGS. 5, and FIG. 8 - FIG. 10).

More specifically, the first return path 75a is in communication with the top portion of the posterior chamber 702 and the bottom portion of the return chamber 703 (see FIG. 5). The second return path 75b is in communication with the top portion of the return chamber 703 and the top portion of the anterior chamber 701 (see FIG. 5).

Furthermore, since the first return path 75a is in communication with the top portion of the posterior chamber 702 and the bottom portion of the return chamber 703 and the second return path 75b is in communication with the top portion of the return chamber 703, air bubbles can easily escape from the diaphragm pump 7. Therefore, malfunction of the diaphragm pump 7 due to accumulation of air bubbles is unlikely to occur.

### Modified example

The diaphragm pump 7 described above may also be applied to a liquid supply device of other liquid ejection devices that eject liquids other than ink.

### Notes of disclosure

Hereinafter, a general outline of the disclosure extracted from the embodiment described above will be noted. It is noted that the respective configurations and processing functions described in the notes below can be sorted and arbitrarily combined as appropriate.

### Note 1

A diaphragm pump, including:
a main body including a plurality of pump chambers each formed with an opening, an inflow path through which liquid that flows from an inflow port toward the plurality of pump chambers flows, an anterior chamber positioned midway through the inflow path, an outflow path through which the liquid that flows from the plurality of pump chambers toward an outflow port flows, a posterior chamber positioned midway through the outflow path, a return path extending from the posterior chamber to the anterior chamber, and a return chamber positioned midway through the return path;
a plurality of diaphragms capable of expanding and contracting, each of the plurality of diaphragms blocking the opening of the plurality of pump chambers;
a crank mechanism which is coupled to the plurality of diaphragms and receives power to cause the plurality of diaphragms to expand and contract;
a plurality of first check valves which permit a flow of the liquid in a first forward direction from the anterior chamber toward the plurality of pump chambers on the inflow path, and block the flow of the liquid in an opposite direction from the first forward direction;
a plurality of second check valves which permit the flow of the liquid in a second forward direction from the plurality of pump chambers toward the posterior chamber on the outflow path, and block the flow of the liquid in an opposite direction from the second forward direction; and
a relief valve which is arranged in the return chamber, blocks the return path, and releases the block of the return path when a difference between a pressure of the anterior chamber and a pressure of the posterior chamber exceeds an upper limit.

### Note 2

The diaphragm pump according to note 1, in which
the return chamber is positioned above the posterior chamber, and
the return path includes
a first return path in communication with a top portion of the posterior chamber and a bottom portion of the return chamber, and
a second return path in communication with a top portion of the return chamber and the anterior chamber.

### Note 3

The diaphragm pump according to note 2, in which
the anterior chamber and the posterior chamber are positioned above the plurality of pump chambers, and
the plurality of diaphragms each block the opening at a lower end of the plurality of pump chambers.

### Note 4

A liquid ejection device, including:
a liquid ejection head which includes a plurality of nozzles and ejects liquid droplets from each of the plurality of nozzles;
a supply path through which liquid to be supplied to the liquid ejection head flows; and
the diaphragm pump according to any one of notes 1 to 3 which is coupled to the supply path and pressurizes the liquid in the supply path.

### Note 5

An inkjet recording apparatus, including:
a sheet conveying device which conveys a sheet; and
the liquid ejection device according to note 4 which ejects ink droplets onto the sheet conveyed, to form an image on the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A diaphragm pump, comprising:
a main body including a plurality of pump chambers each formed with an opening, an inflow path through which liquid that flows from an inflow port toward the plurality of pump chambers flows, an anterior chamber positioned midway through the inflow path, an outflow path through which the liquid that flows from the plurality of pump chambers toward an outflow port flows, a posterior chamber positioned midway through the outflow path, a return path extending from the posterior chamber to the anterior chamber, and a return chamber positioned midway through the return path;
a plurality of diaphragms capable of expanding and contracting, each of the plurality of diaphragms blocking the opening of the plurality of pump chambers;
a crank mechanism which is coupled to the plurality of diaphragms and receives power to cause the plurality of diaphragms to expand and contract;
a plurality of first check valves which permit a flow of the liquid in a first forward direction from the anterior chamber toward the plurality of pump chambers on the inflow path, and block the flow of the liquid in an opposite direction from the first forward direction;
a plurality of second check valves which permit the flow of the liquid in a second forward direction from the plurality of pump chambers toward the posterior chamber on the outflow path, and block the flow of the liquid in an opposite direction from the second forward direction; and
a relief valve which is arranged in the return chamber, blocks the return path, and releases the block of the return path when a difference between a pressure of the anterior chamber and a pressure of the posterior chamber exceeds an upper limit.

2. The diaphragm pump according to claim 1, wherein
the return chamber is positioned above the posterior chamber, and
the return path includes
a first return path in communication with a top portion of the posterior chamber and a bottom portion of the return chamber, and
a second return path in communication with a top portion of the return chamber and the anterior chamber.

3. The diaphragm pump according to claim 2, wherein
the anterior chamber and the posterior chamber are positioned above the plurality of pump chambers, and
the plurality of diaphragms each block the opening at a lower end of the plurality of pump chambers.

4. A liquid ejection device, comprising:
a liquid ejection head which includes a plurality of nozzles and ejects liquid droplets from each of the plurality of nozzles;
a supply path through which liquid to be supplied to the liquid ejection head flows; and
the diaphragm pump according to claim 1, which is coupled to the supply path and pressurizes the liquid in the supply path.

5. An inkjet recording apparatus, comprising:
a sheet conveying device which conveys a sheet; and
the liquid ejection device according to claim 4, which ejects ink droplets onto the sheet conveyed, to form an image on the sheet.
